(19) United States
(12) Patent Application Publication
(10) Pub. No.: US 2007/0183040 A1
(43) Pub. Date: Aug. 9, 2007

(54) Device for obtaining light images

(76) Inventors: Andrei V. Sinyugin, Kharkov (UA); Yuriy A. Goncharenko, Artemievsk (UA); Yuriy I. Martinov, Kharkov (UA); Guennadi Soubbotine, Brooklyn, NY (US)

Correspondence Address: Ilya Zborovsky, 6 Schoolhouse Way, Dix Hills, NY, 11746, US

(21) Appl. No.: 10/625,454

(22) Filed: Jul. 24, 2003

(30) Foreign Application Priority Data
Mar. 13, 2003 (UA) 2003032202

(51) Int. Cl. G02B 5/12

(52) U.S. Cl. 359/515

(57) ABSTRACT

A device for obtaining a light image has at least one light source, a transparent volume, at least one block associated with the volume and having dispersing centers, a control block operative for controlling intensity, color and time of illumination of a light flux which is produced by the at least one light source, and at least one additional optical element for introduction of the light flux, the at least one additional optical element having an input at which the at least one light source is located and an output which is optically connected with the transparent volume, the at least one additional optical element having a geometry which provides a directional introduction of the light flux into the volume at an angle which is greater than a critical angle, wherein S₁/S₂=3 . . . 10, where S₁ is an area of an output cross-section of the at least one additional optical element, S₂ is an area of an output cross-section of the at least one additional optical element, and a coefficient of refraction of the at least one additional optical element and a coefficient of refraction of the transparent volume are related as n₂≧n₁, where n₂ is a coefficient of refraction of the at least one additional optical element, and n₁ is a coefficient of refraction of the transparent volume.

### BACKGROUND OF THE INVENTION

The present invention relates to devices for obtaining light images, and can be used with advertising and demonstration means with special effects, providing visually observed three dimensional color images with an unusual light effect, which creates a special decorative effect reproducible in volumes and on surfaces.

A method of illumination of a screen, based on the use of a transparent surface with light diodes and matted parts of the surface on its inner surface is disclosed for example in SU 1727158. Since radiation from the surface of light diodes takes place with a directional diagram of Lambert-type in which a part of rays, impinging the border separating glass and air at angles which are greater than critical angles, have a complete inner reflection, the reflected rays which fall on the matted portions of the plate light up the dark zones of the screen. By changing the index of refraction of the transparent surface, it is possible to change the magnitude of the flux which is subjected to full internal reflection, so as to change the brightness of illuminated zones of the screen.

However, this image is used, mainly in devices for representing information, since other possibilities to influence the light flux are not provided there. Moreover, on the one hand the positioning of the light diodes directly on the surface to be illuminated is not always possible, and on the other hand the illumination has a static nature which reduces the possibility of its use in advertising and similar applications.

Another device for obtaining a light flux is disclosed in SU1 253,853 and includes a transparent plate with an image produced on its face surface by engraving and with a light-reflecting non-transparent coating, as well as a light source located at the non-coated surface of the plate. The device also has an additional transparent plate of the same size as the plate which carries the image and located from the rear side of the main transparent plate with the light-reflecting non-transparent coating. The non-transparent light-reflecting coating utilizes layers of black and white paint and colorless matted lacquer, while the light source is located so that it can illuminate simultaneously the edge surface of the additional plate and the main plate.

The use of two transparent plates with the light-reflecting coating of the second plate allows to eliminate flashes from the engraving, increases contrast and visibility of the image, increases brightness in dark time of the day due to the presence of the additional plate.

However, it is not always possible to use the second plate which has the same size as the main plate and to locate the light source at the edge of the plates. These aspects limit the possibility of the use of the above mentioned technical solution, for example for advertising purposes. The additional plate of the same size as the main plate significantly increases the cost for manufacturing of the devices with large sizes. In addition, the static attractiveness of the device is not sufficient since the decorative image is obtained only by the engraving on the surface of the main plate.

A solution which is the closest to the present invention is disclosed in UA 411,95 which discloses a device for obtaining light images which has a light source and a transparent volume with at least one additional block located in the volume or on its surface and has dispersing centers which are artificially created in it or introduced into it. The light source also is located in the edge surface of the plate. This solution allows to create aesthetic and attractive decorative images which are equally attractive in any time of the day. However, as in the preceding solutions, the edge side illumination of the decorative panels significantly reduces the possibility for use of the solution, since dispersing centers are too far from the light source and the efficiency of illumination is reduced. Moreover, it is not always possible to position the light sources at the edge, for example, of a sheet if its already introduced into a frame or a composition.

### SUMMARY OF THE INVENTION

Accordingly, it is an object of the present invention to provide a device for obtaining a light image which has expanded functional possibilities, a simplified construction, and reduced cost for manufacturing of decorative panels and other objects, when compared with known solutions.

The invention is based on the objective of improvement of the device for obtaining a light image, which is formed with one or two additional optical elements for introduction of light flux, with a light sources located at their inputs, while the outputs are connected with a transparent volume, the geometry of additional optical elements is selected so that a directional introduction of the light flux is provided into the plate with angles which are greater than a critical angle, wherein S₁/S₂=3 . . . 10, where S₁ is an area of an output cross-section of additional optical elements, S₂ is an area of an input cross-section of the additional optical elements, and coefficients of refraction of the additional optical elements and the transparent volume are related as n₂≧n₁, where n₂ is a coefficient of refraction of the additional optical element, n₁ is a coefficient of refraction of the transparent volume, and thereby the introduction of the light source is provided in any accessible point of the side surface of the transparent volume into it directionally and at the angles which are greater than the critical angle. As a result, the functional possibilities of the device are expanded and its cost is reduced.

The main plate can be formed for example by a glass of the already existing window. Therefore, the most expensive element of advertising device, namely the plane-parallel plate, which is optically transparent and has a polished surface, is supplemented by the existing article with a not complicated mounting process.

The above mentioned objective, is achieved in that, in the known device for obtaining a light image which contains a light source and a transparent volume with at least one additional block which is located in the volume or on its surface, with centers which are artificially formed or introduced into it, in accordance with the invention the device is provided with a block for controlling intensity, color and time of lighting up of a light flux, created by one or several light sources, with one or several additional optical elements for introduction of the light flux with the light sources located at their inputs, while the outputs are optically connected with the transparent volume, with a geometry of the additional optical elements providing a directional introduction of the light flux into the plate with angles which are greater than a critical angle, wherein S₁, S₂=3 . . . 10, where S₁ is an area of an output cross-section of the additional optical elements, S₂ is an area of the input cross-section of the additional optical elements, and the coefficient of refraction of the additional optical elements and the transparent volume are selected with the ratio n₂≧n₁ where n₂ is a coefficient of refraction of the additional optical element, n₁ is a coefficient of refraction of the transparent volume.

In accordance with the invention, the additional optical element is formed as a plane-parallel plate which has an optical contact with a transparent, for example plane-parallel panel.

In accordance with the invention, the original optical element is formed as a wedge, with a surface S₂ which is flat and perpendicular to the surface of the transparent volume, for example to the surface of the plane-parallel transparent panel.

In accordance with the invention, the surface S₂ is formed convex or inclined to the surface, for example to the plane of the surface of the plane-parallel transparent panel.

In accordance with the invention, one of the surfaces of the device, for example the edge surface of the plane-parallel transparent panel, is formed as a mirror surface.

A solution is also known for demonstration of the information, which is disclosed in UA 39,770 and has a light-conducting element composed of optically transparent material with polished surfaces with at least one diffusion-reflecting sign located on at least one of the surface with a light source for illumination the diffusion-reflecting sign, and with at least one additional light-conducting element composed of an optically transparent material with polished surfaces, on of which the diffusion-reflecting sign is located, and is in conformity to the light-conducting element, wherein the device has at least one additional light source for lighting up the diffusion-reflecting sign, wherein the lighting up of the diffusion-reflecting sign is provided by point light sources, and the device has a block for electronic-software control of the point light sources.

However, the present invention is significantly different in that it allows to eliminate the edge illumination, to use a plurality of variants of introduction of the light flux for example into the information screen, so as to put the light sources closer to the carriers of information located in the transparent volume.

The novel features which are considered as characteristic for the present invention are set forth in particular in the appedgeed claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a diagram of the device with introduction of a light flux through a plane-parallel plate from several light sources;

FIG. 2 is a view showing a path of rays in a transparent panel with introduction of the light flux through a plane-parallel plate (S₁/S₂=10, and n₂=n₁=1.5);

FIG. 3 is a view showing a diagram of a device with introduction of the light flux through an optical element formed as a wedge from several light sources (S₁/S₂=7, and n₂=n₁=1.5;

FIG. 4 is a view showing a path of rays in the transparent panel with introduction of the light flux through an optical element formed as a wedge (S₁/S₂=3 and n₁=1.5, and n₂=1.8);

FIG. 5 is a view showing a path of rays during introduction of the light flux through a surface formed as a part of a spherical surface (S₁/S₂=5 and n₂=n₂=1.5)

FIG. 6 is a view showing a path of rays during introduction of the light flux through a surface formed as an inclined surface (S₁/S₂=5 and n₂=n₁=1.5);

FIG. 7 is a view showing a path of rays during introduction of the light flux through a surface formed an inclined surface with a mirror surface at the edge of the plan-parallel panel (S₁/S₂=7, n₂=n₁=1.5); and

FIG. 8 is a view showing a path of rays during introduction of the light flux through a surface formed as an inclined surface with a mirror surface at the edge of the plane-parallel panel, which is also inclined toward the plane of the panel (S₁/S₂=7, n₂=n₁=1.5).

### DESCRIPTION OF THE PREFERRED EMBODIMENTS

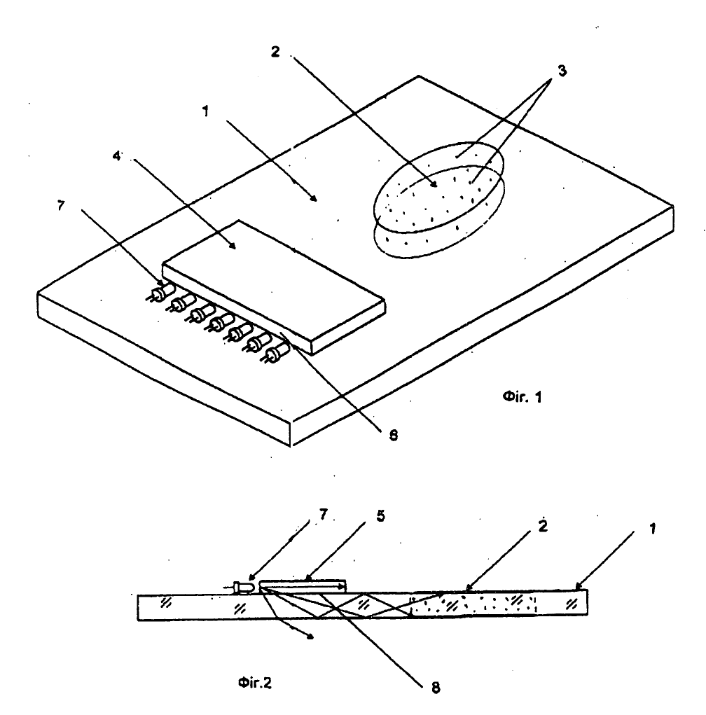

A device for obtaining a light image shown in FIG. 1 has a transparent volume 1 which is formed for example of organic glass as a panel. The transparent panel 1 in this case contains one additional block 2 which is located in it and has dispersing centers 3 which are artificially formed in it. Since the panel 1 will be located as an advertising board in a window opening, the positioning of the light sources at the edges is not possible.

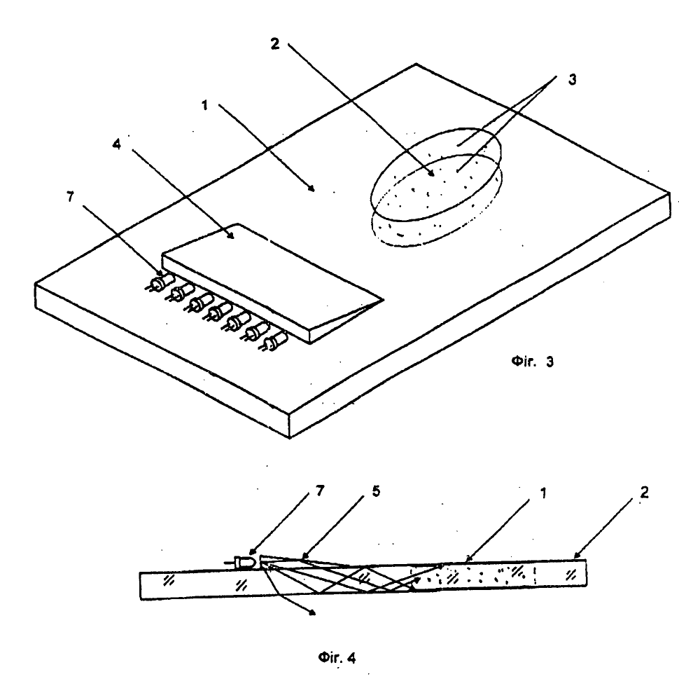

Therefore, a transparent plane-parallel plate 4 (or an optical wedge shown in FIG. 3) with a mirror coating 5 is located on the panel 1. Light sources 7 are located in the edge 6 of the plate 4, and their modes of operation are determined by a not shown block for controlling intensity, color and time of lighting up of the light flux.

The plane-parallel plate 4 at the input 6 of the light flux has an area S₂ which is equal 0.5 cm², and the surface 8 which adjoins the surface of the panel has an area S₁=1.5-5.0 cm². The coefficient of refraction of the plane-parallel plate 4 is n₂=1.5, the coefficient of refraction of the transparent panel 1 is n₁=1.5.

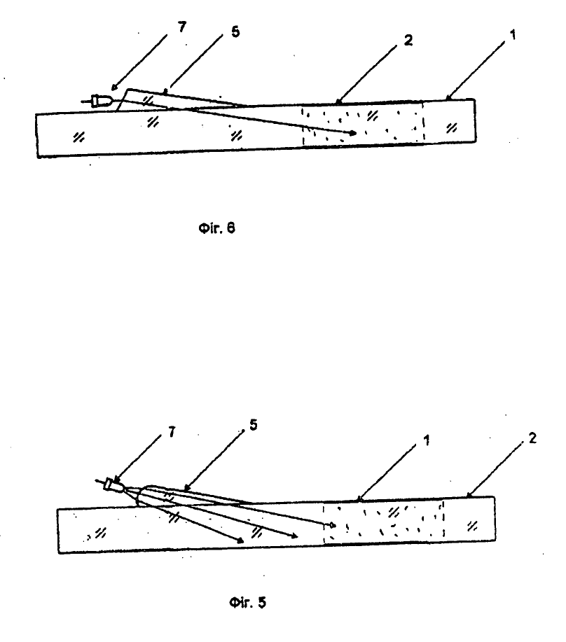

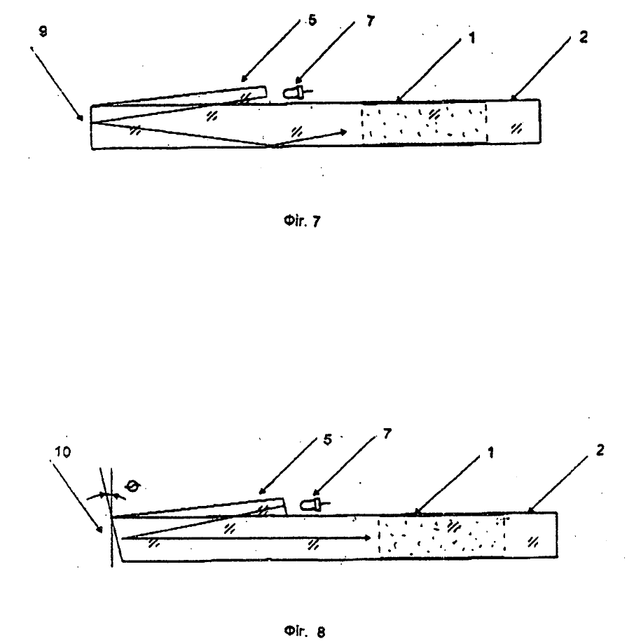

The device operates as shown in FIGS. 2, 4-8, or in other words light from the light source 7, for example a light diode, passes for example through the edge 6 of the plate 4. After passing the border of separation 8, light partially intersects the panel 1 and, being refracted, leaves the panel 1. The major part of the light flux propagates along the panel 1, having a full internal reflection from the surfaces of the panel 1, and is dispersed on the dispersing centers 3. It is possible to increase the quantity of light directed along the panel 1, if the input surface is formed for example as an inclined surface or a spherical surface as shown in FIGS. 5 and 6, or if the edges of the main panel are also mirrored, perpendicular or inclined as shown in FIGS. 7 and 8.

As can be seen from the description of the examples of implementation of the inventive device, a maximum illumination, for example, of the flat surface can be provided with the use of the light sources located on the surface of the transparent volume practically at any location. It is not necessary to use the edge illumination. The device can also operate on the already manufactured transparent panels without their significant reconstruction. Therefore the functional possibilities of the proposed device are much broader than in the known devices.

In the examples illustrated in the drawing, in FIG. 1 the device is designed so that the light flux is introduced through the plane-parallel plate from the several light sources. The path of the rays in the transparent panel with introduction of the light flux through the plane-parallel panel is shown in FIG. 2, wherein S₁/S₂=10, and n₂=n₁=1.5.

In the device shown in FIG. 3, the introduction of the light flux is performed through the optical element formed as a wedge, from several light sources, wherein S₁/S₂=7, and n₂=n₁=1.5. The path of rays in the transparent panel with the introduction of the light flux through the optical element formed as a wedge is shown in FIG. 4, wherein S₁/S₂=3, n₂1.5 and n₁=1.8.

FIG. 5 shows the path of rays during the introduction of the light source through the surface formed as a part of the spherical surface, wherein S₁/S₂=5, and n₂−n₁=1.5.

FIG. 6 shows the path of rays with the introduction of the light flux through the surface formed as an inclined surface, wherein S₁/S₂=5, n₂=n₁=1.5.

FIG. 7 shows a path of rays during the introduction of the light flux through the surface formed as an inclined surface with a mirror surface at the edge of the plane-parallel panel, wherein S₁/S₂=7 and n₂=n₁=1.5.

Finally, FIG. 8 shows the path of rays when the light flux is introduced through the surface formed as an inclined surface with a mirrored surface at the edge of the plane-parallel pile, also inclined toward the plan of the panel, wherein S₁/S₂=7, and n₂−n₁=1.5.

It will be understood that each of the elements described above, or two or more together, may also find a useful application in other types of constructions differing from the types described above.

While the invention has been illustrated and described as embodied in device for obtaining light image, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A device for obtaining a light image, comprising at least one light source; a transparent volume; at least one block associated with said volume and having dispersing centers; a control block operative for controlling intensity, color and time of illumination of a light flux which is produced by said at least one light source; and at least one additional optical element for introduction of the light flux, said at least one additional optical element having an input at which said at least one light source is located and an output which is optically connected with said transparent volume, said at least one additional optical element having a geometry which provides a directional introduction of the light flux into said volume at an angle which is greater than a critical angle, wherein S₁/S₂=3 . . . 10, where S₁ is an area of an output cross-section of said at least one additional optical element, S₂ is an area of an input cross-section of said at least one additional optical element, and a coefficient of refraction of said at least one additional optical element and a coefficient of refraction of said transparent volume are related as n₂≧n₁, where n₂ is a coefficient of refraction of said at least one additional optical element, and n₁ is a coefficient of refraction of said transparent volume.

2. A device as defined in claim 1, wherein said at least one block with said dispersing centers is located in said transparent volume.

3. A device as defined in claim 1, wherein said at least one block with said dispersing centers is located on a surface of said transparent volume.

4. A device as defined in claim 1, wherein said dispersing centers are artificially formed in said at least one block with said dispersing centers.

5. A device as defined in claim 1, wherein said dispersing centers are introduced in said block with said dispersing centers.

6. A device as defined in claim 1, wherein said transparent volume being formed as a transparent panel, said at least one additional optical element is formed as a plane-parallel plate which has an optical contact with said transparent panel.

7. A device as defined in claim 6, wherein said transparent panel is formed as a plane-parallel panel.

8. A device as defined in claim 1, wherein said at least one additional optical element is formed as a wedge with a surface which has flat and perpendicular to a surface of said transparent volume.

9. A device as defined in claim 8, wherein said transparent volume is formed as a plane-parallel transparent panel, said surface of said wedge being perpendicular to a surface of said plane-parallel transparent panel.

10. A device as defined in claim 1, wherein said at least one additional optical element has a surface which is curved and inclined to a surface of said transparent volume.

11. A device as defined in claim 10, wherein said transparent volume is formed as a plane-parallel transparent panel, said curved surface of said at least one additional optical element is inclined toward a plane of a surface of said plane-parallel transparent panel.

12. A device as defined in claim 1, wherein at least one of surfaces of the device is formed as a mirror surface.

13. A device as defined in claim 1, wherein said transparent volume is formed as a plane-parallel transparent panel with at least an edge surface formed as a mirror surface.
